(19) United States
(12) Patent Application Publication
(10) Pub. No.: US 2008/0032249 A1
(43) Pub. Date: Feb. 7, 2008

(54) LIGATURE DEVICE

(75) Inventors: Gabriele SCOMMEGNA, Tavarnuzze Impruneta (FI) (IT); Maurizio DOLFI, Firenze (IT)

Correspondence Address: McGLEW AND TUTTLE;John James McGlew, Scarborough Station, Scarborough, NY, 10510-9227, US

(73) Assignee: LEONE S.P.A.

(21) Appl. No.: 11/842,292

(22) Filed: Aug. 21, 2007

Related U.S. Application Data
(63) Continuation of application No. 11/116,583, filed on Apr. 28, 2005.

(30) Foreign Application Priority Data
May 26, 2004 (IT) FI2004U000044

(51) Int. Cl. A61C 7/30

(52) U.S. Cl. 433/11

(57) ABSTRACT

Ligature device for orthodontic brackets, consisting of an elastic body with a central portion (5) and two lateral rings (6) positioned on two mesodistal sides of the central portion (5), on opposite sides with respect to the latter, the rings being intended to be stretched to be coupled with the wings (2) of an orthodontic bracket so that the central portion (5) results above the same bracket wings (2), characterized in that the lateral rings (6) form at least a curve (65) corresponding to a mesodistal side of the orthodontic bracket at the height of the wings (2), the vertex of the at least one curve (65) being turned toward the orthodontic bracket, that is to say toward the central portion (5) of the ligature device, the length (a) of each of the rings (6) exceeding the length (c) of the central portion (5) both when the rings (6) are stretched and un-stretched, so that the value of the ratio (a)/(c) is less than one in both the stretched and un-stretched configurations.

### CROSS REFERENCE TO RELATED APPLICATION

This application is a continuation application under 37 CFR 1.53(b) of pending prior application number 11/116,583 filed Apr. 28, 2005.

### FIELD OF THE INVENTION

The present invention relates to a ligature device for orthodontics.

### BACKGROUND OF THE INVENTION

Orthodontic procedures, in which a plurality of orthodontic brackets are used, have widely been adopted for a long time. Each orthodontic bracket is cemented on the vestibular face of a tooth which belongs to a dental arch under treatment. Along each dental arch, a suitably preformed wire arch passes through the orthodontic brackets. On this purpose, each orthodontic bracket features a slot extending in the mesodistal direction, in which the above wire passes, as well as a retention base. The slot is positioned between two couples of wings emerging from said base which extend in the occlusal gingival direction, between which an elastic ring commonly said “binding” or “ligature” is applied, so as to prevent the wire escaping out of the slot.

A well-known ligature system is shown in FIG. 1 of the enclosed drawings, in which “A” indicates the orthodontic bracket, “B” indicates the corresponding base, “F” indicates the wire, “S” indicates the slot for wire “F”, “L” indicates the ligature ring and “W” indicates the coupling wings for the ligature ring “L”.

As the preformed wire, once it has been positioned in the slots of the complex of orthodontic brackets applied on the patient's teeth, tends to assume its original form, that is to say a form corresponding to an ideal dental arch, it produces a complex of corrective forces and transmits these forces to the each single tooth by means of the corresponding orthodontic brackets. However, as in the above ligature systems the movements of the preformed wire, which tends to assume its original form, generate remarkable friction due to the contact between the wire itself and the ligature rings mounted on each orthodontic bracket, the elastic energy accumulated in the wire is partially consumed to eliminate friction, so there is a general tendency to oversize the elastic load applied to the wire during the preforming phase. As each single ligature ring tends to lose its elasticity with time and the materials employed to build the preformed wires are such that the elastic energy returned to its original arch conformation during the return phase is constant during the time, the load applied on each tooth progressively increases. This may lead to serious biological damages for the patient and compels the odontologist to examine him frequently.

U.S. Pat. No. 5,540,586 discloses a reinforced elastomeric non-hoop ligature comprising a thin flat body of the elastomeric material having incorporated therein a thin flat rigid insert of gingival-occlusal dimension greater than the corresponding dimension of the arch-wire receiving slot of the orthodontic bracket with which it is employed. The rigid insert is intended to provide the possibility of controlling sliding friction between the arch-wire and the bracket.

A drawback of the above-mentioned ligature lies in that it is quite complex from a structural and manufacturing point of view and, consequently, it is quite expensive. DE 10013818 discloses a ligature made of elastic material, comprising a central rectangular portion and two side rings provided on opposite sides with respect to the central portion. Each of the rings has a semicircular shape. When the ligature is to be mounted onto a bracket, each of the rings is to be stretched. Obviously, the stretching step is to be carried out with the bracket being applied to the respective tooth but, in relation the very small dimensions of both the bracket and the ligature, the stretching step results in a quite complex operation for the odontologist. Moreover, the stretching step involves remarkable stressing forces at the interface between the tot and the bracket base, the latter being, in fact, cemented to the tot vestibular face. Consequently, the cement applied between the tot and the bracket base may be subject to weakening. Furthermore, the bracket may be subject to displacement.

### SUMMARY OF THE INVENTION

The present invention aims at eliminating or at least at reducing the above inconveniences.

These results have been achieved, according to the present invention, by a device having the features described in claim 1. Further features of the present invention are the subject of the dependent claims. Thanks to the present invention it is possible to guarantee an improved possibility of movement of the preformed wire both in the mesodistal direction and by flexion, outside the bracket wings, without modifying the shape or the nature of the preformed wire or of the orthodontic bracket. Therefore, the elastic overload of the wire during its pre-forming phase can be eliminated or considerably reduced, so as to allow a more correct application of the corrective forces on the interested teeth. Moreover, the binding or ligature device according to the present invention allows a remarkable reduction of the orthodontic treatment time, is easy to build, economic, comfortable for the patient, easy to use and reliable, even after a relatively long working time.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a schematic perspective view of a well-known ligature device mounted on an orthodontic bracket;

FIG. 2 is a schematic perspective view of a ligature device according to the present invention mounted on the same orthodontic bracket of FIG. 1;

FIG. 3 is a view identical to that of FIG. 2 which schematically shows a possible movement of the wire inside and outside the corresponding slot;

FIG. 4 is a schematic view from “K” of the device shown in FIG. 3;

FIG. 5 is a schematic plant view of the device shown in FIG. 2;

FIG. 6 is a schematic plant view of a ligature device according to the present invention in a rest configuration, that is in an un-stretched or non-use configuration;

FIGS. 7-9 are schematic views showing an apparatus used to test a ligature device according to the present invention and compare its characteristics with those of a conventional ligature device;

FIGS. 10-14 are schematic views showing the positioning of a ligature device according to the present invention on a conventional bracket;

FIG. 15 is a plant view of a further embodiment of a ligature device according to the present invention; and

FIG. 16 is a perspective view of the device shown in FIG. 15 in a use position.

### DESCRIPTION OF THE PREFERRED EMBODIMENT

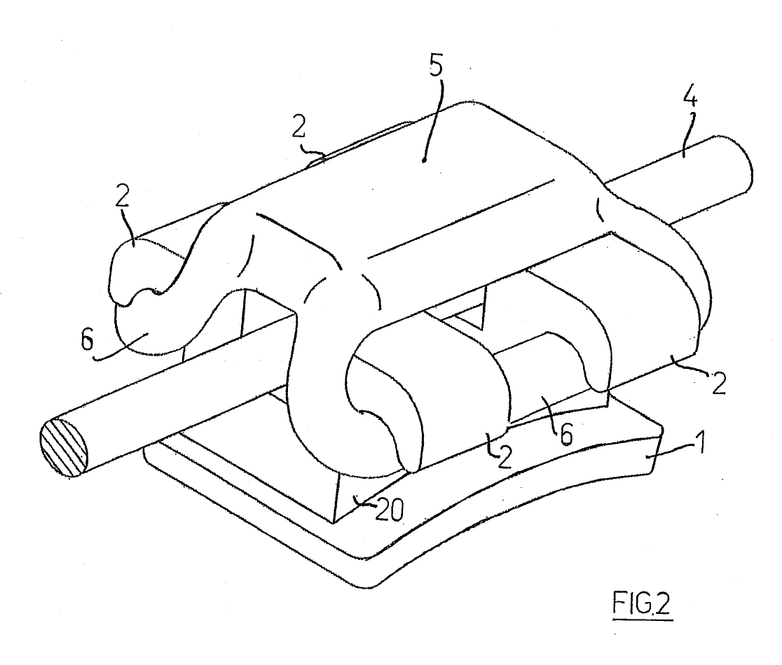

According to FIGS. 2-5 of the enclosed drawings, a ligature device for orthodontic brackets according to the present invention is designed to be mounted on any orthodontic bracket available on the market, that is to say an orthodontic bracket comprising a base (1) with a surface (10) to be cemented on the vestibular face of a tooth and more wings defined by a body (20) which emerges from the base (1) on the side opposite to that of the surface (10). Wings (2) extend in the occlusal gingival direction, while a slot (3) extends between them in the mesodistal direction, so as to allow the passage of a corresponding arch portion of a preformed wire (4). Moreover, each of the wings (2) features a lower surface, that is to say a surface (21) which is turned toward the base (1) of the orthodontic bracket so that the ligature device can be coupled with it, as described in detail below.

The wire (4) can be of any kind available on the market.

A ligature device according to the present invention consists of a body in elastic, biocompatible material, comprising a central potion (5) having a basically rectangular plant and two side rings (6), that is to say two rings which are on opposite sides with respect to the central portion (5). The rings (6) are basically developed along the longer sides of said central portion (5), that is to say developed according to the mesial-distal direction.

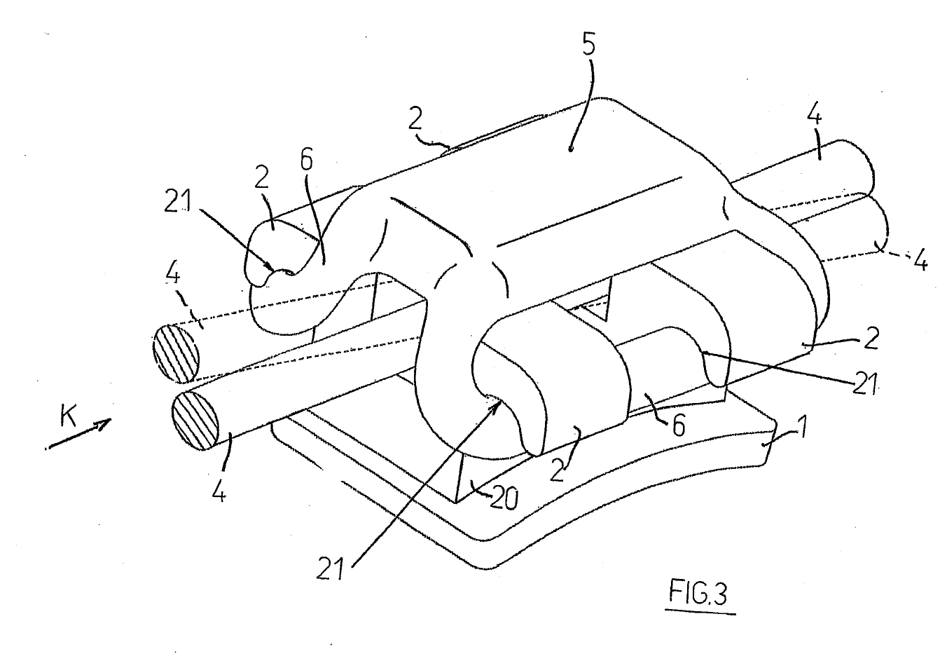

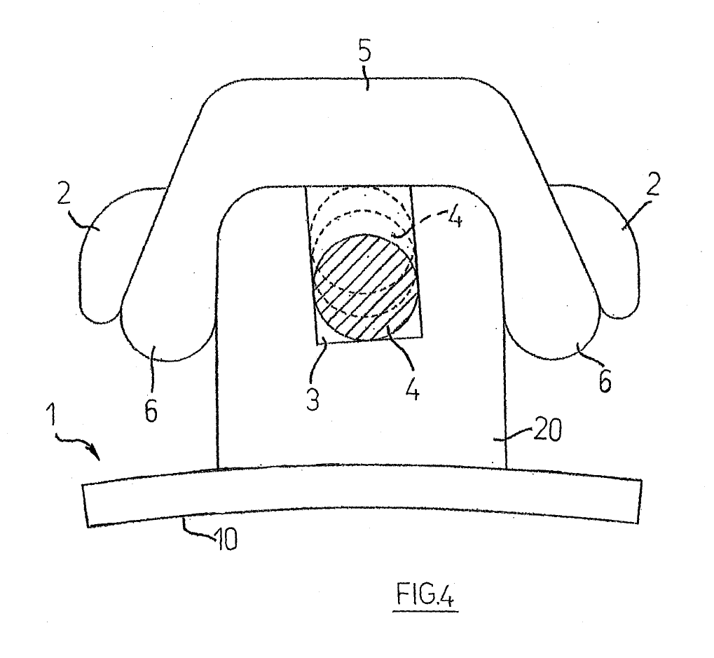

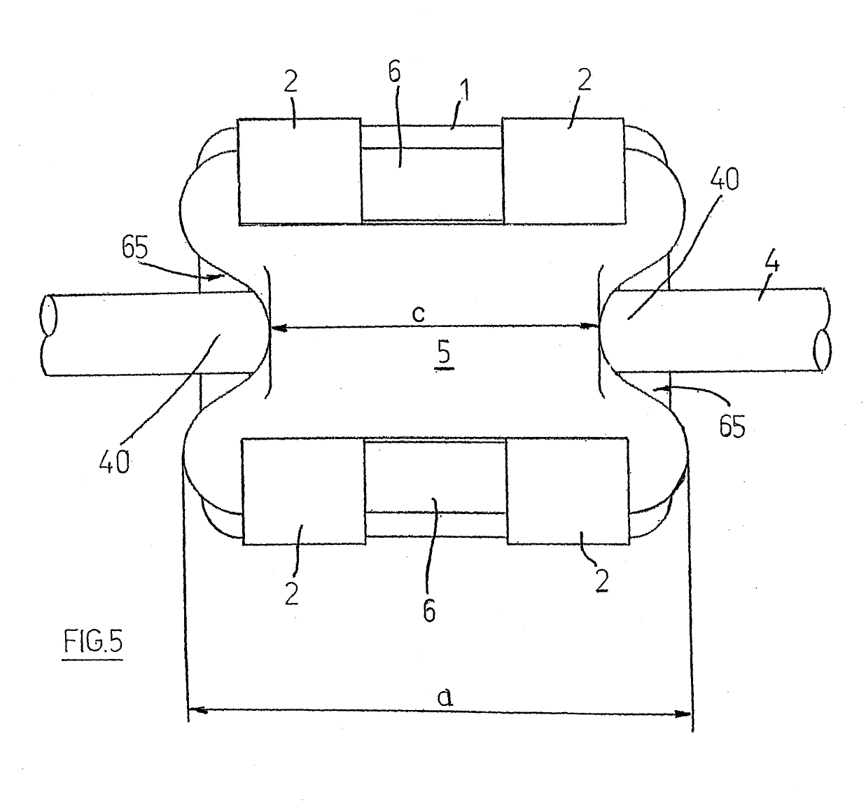

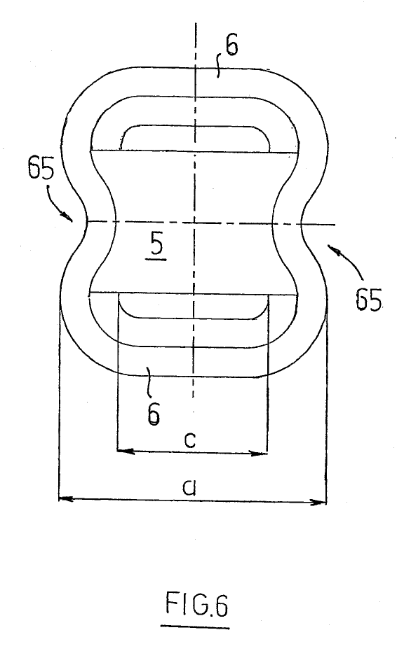

According to the example shown in FIGS. 2-5 of the enclosed drawings, each of the longer sides of the central portion (5) is also a part of a corresponding ring (6). The body (5, 6) consists of a single, i.e. unitary, element and the length (a) of each lateral ring (6) exceeds the length (c) of the central body (5). In this way, as the central portion (5) of the ligature device is mounted above the wings (2) of a corresponding orthodontic aid and the lateral rings (6) are coupled with the lower surfaces (21) of the same wings, and the rings are longer than the central portion, the wire (4) cannot escape out of the slot but it is free to move in correspondence of the two shorter sides of the central portion (5). In other terms, as rings (6) are longer than the central portion (5) of the ligature device, the latter is provided with two curves (65), well visible in the plant view of FIG. 5, as well as in FIG. 6, which leave two corresponding portions (40) of the wire (4) uncovered. Therefore, the wire portions (40) are free to move (compatibly with the upper link consisting of the central portion 5 of the device and with the lower link consisting of the base 1 of the orthodontic bracket) as FIGS. 3 and 4 schematically show. The vertex of each of the curves (65) is turned toward the orthodontic bracket, that is to say toward the above mentioned central portion (5). These features of the ligature device offer the above-mentioned advantages.

The length (a) of each lateral ring (6) exceeds the length (c) of the central body (5) both when the device is in use, i.e. applied to the bracket as shown in FIGS. 2-5, and when the device is in a rest condition, that is to say before to be applied to the bracket, as in FIG. 6. In other words, the above-mentioned curves are pre-formed curves. Again in other words, the present ligature device provides the above-mentioned curves when it is stretched, that is, in use, as well as when it is un-stretched, that is, relaxed or not in use. Therefore, the value of ratio (a)/(c) is ever less than one (a/c<1).

The example shown in FIGS. 2-6 of the enclosed drawings refers to a symmetric embodiment of the ligature device, with the curves (65) which are symmetrically positioned in correspondence of the two short sides of the central portion (5).

However, the above device can obviously be asymmetric, i.e. it can feature only one of the curves (65) in correspondence of one short side of the central portion (5) of the ligature device. In this case, the above mentioned freedom of movement of wire (4) is guaranteed on one side of the orthodontic bracket only instead of on both sides of the latter.

“Long side” or “longer side” obviously means a side which extends in the mesodistal direction and “short side” or “shorter side” means a side which extends in the occlusal-gingival direction.

The above device can be made, for example, in thermoplastic polyuretane, in any color.

The hardness of the material used for the above ligature device preferably ranges from Shore A 80 to Shore A 90.

Tests have been carried out to compare the frictional forces generated by the present elastomeric ligature (NCL) and conventional elastomeric ligatures (CL). An experimental model reproducing the right buccal segment of the upper arch and consisting of five stainless steel 0.022″ preadjusted brackets (from the second premolar through the central incisor) was used to assess both static and kinetic frictional forces produced by NCL and by CL. The frictional forces generated by 0.01 9″×0.025″ stainless steel wire with the two types of elastomeric ligatures were recorded by sliding the wire onto the aligned brackets. The friction produced by 0.014″ super elastic nickel titanium wire was evaluated both in presence of aligned brackets and of 3-mm misaligned canine bracket. The amount of both static and kinetic friction was minimal (<10 g) in the NCL group in presence of aligned brackets with both types of wires, while it ranged from a minimum of 95.6 g for the 0.014″ super elastic nickel titanium wire to a maximum of 590.7 g for the 0.019″×0.025″ stainless steel wire when using CL. The amount of both static and kinetic friction in presence of misaligned canine bracket in the NCL group was less than the half of that shown by the CL group.

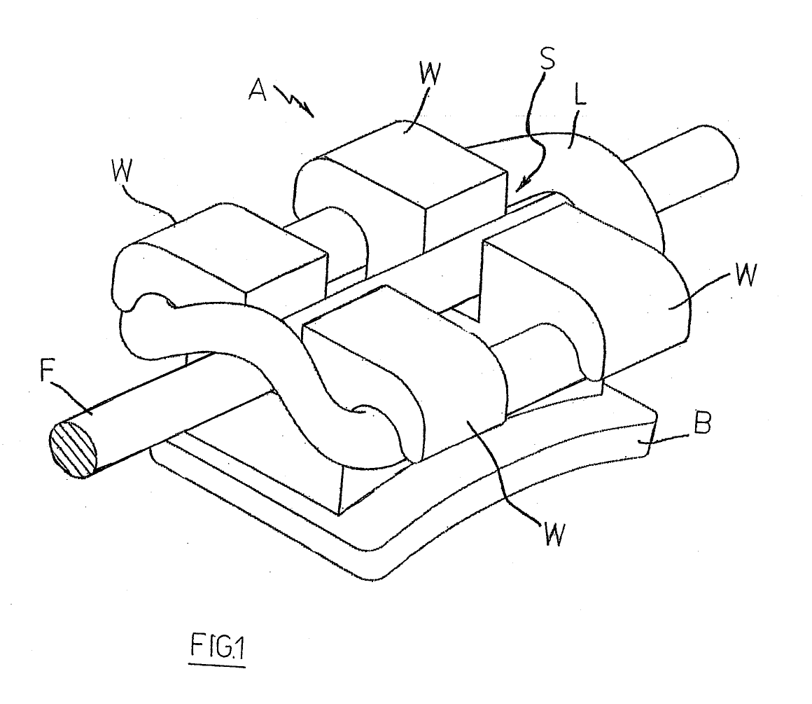

An experimental model reproducing the right buccal segment of the upper arch was used to assess the frictional forces produced by the present non-conventional elastomeric ligatures (NCL) (FIGS. 2-6) and by conventional elastomeric ligatures (CL) (FIG. 1). All materials used in this study were supplied by Leone Orthodontic Products (Sesto Fiorentino, Firenze, Italy). The buccal segment model consisted of five stainless steel 0.022″ preadjusted brackets for the second premolar, first premolar, canine, lateral incisor, and central incisor (STEP® brackets). A section of 0.021 5″×0.028″ stainless steel wire was used to align the brackets prior to blocking them inside a vice-like device (FIG. 8). The distance between the brackets was set at 19 mm.

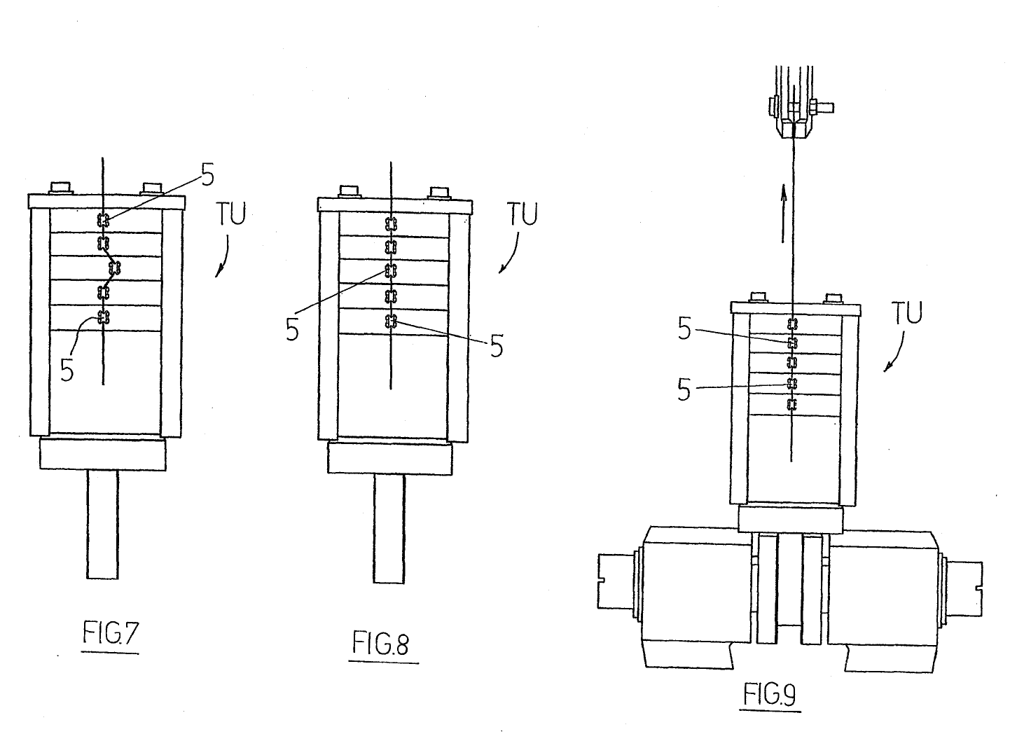

Two different types of 18-cm-long wires were tested: 0.01 9″×0.025″ stainless steel wire and 0.014″ super elastic nickel titanium wire (Memoriam® wire). The two types of wires were secured into the preadjusted brackets by using two types of elastomeric ligatures produced by injection molding: non-conventional ligatures and conventional elastomeric ligatures (silver mini modules). The frictional forces generated by the 0.01 9″×0.025″ stainless steel wire with the two types of elastomeric ligatures were recorded by sliding the wire into the aligned brackets. Friction produced by the 0.014″ super elastic nickel titanium wire with the two types of elastomeric ligatures was evaluated both in presence of aligned brackets and of misaligned canine bracket (FIG. 7). The vice-like device was allowed to create a 3 mm misalignment of the canine bracket in an upward direction.

The friction generated by the testing unit consisting of wire, brackets, and elastomeric ligatures were measured under dry conditions and at room temperature (20°±2° C.) by means of an Instron 4301 testing machine (Instron Corp., Canton, Mass., USA) with a load cell of 10 Newton. The testing unit is denoted by the reference “TU” in FIGS. 7-9. The test wire was inserted into the testing unit and its bottom end clamped by a vice and mounted on the Instron crosshead (FIG. 9). The elastomeric ligatures were placed immediately before each test run, to avoid ligature force decay. Frictional forces produced by each wire/ligature combination with aligned brackets for the 0.019″×0.025″ stainless steel wire, and with both aligned and misaligned brackets for the 0.014″ super elastic nickel titanium wire were tested 10 times with new wires and ligatures on each occasion.

A total of 60 tests (30 tests for each type of elastomeric ligatures) were carried out. Static and kinetic friction forces were recorded while 15 mm of wire were drawn through the brackets at a speed of 15 mm/min. Static friction was defined as the force needed to start the wire moving through the bracket assembly. This force was measured as the maximal initial rise on the Instron chart trace. Kinetic friction was calculated by averaging the recordings after 2 mm, 5 mm and 10 mm of movement.

Descriptive statistics including mean, median, standard deviation (SD), minimum, and maximum values were calculated for the static and kinetic frictional forces produced by wire/ligature combination with both aligned brackets and misaligned brackets. As normal distribution of the data was not found (Shapiro Wilk test), the comparisons between the results for the two types of ligatures were carried out by means of a non-parametric test for independent samples (Mann-Whitney U Test).

All statistical computations were performed by means of statistical software (SigmaStat 3.0, SPSS Inc. Chicago, Ill., USA).

The descriptive statistics and the analysis of the comparisons on static and kinetic frictional forces for the two ligature systems are shown in Tables 1 and 2. The Mann-Whitney test revealed significant differences between CL and NCL for both types of frictional forces for all tested variables (p<0.001):use of 0.019″×0.025″ stainless steel wire with aligned brackets, and use of 0.014″ super elastic nickel titanium wire both in presence of aligned brackets and of 3 mm-misaligned canine bracket.

The amount of both static and kinetic friction was minimal (<10 g) in the NCL group in the presence of aligned brackets with both 0.019″×0.025″ stainless steel and 0.014″ super elastic nickel titanium wires, while it ranged from a minimum of 95.6 g for the 0.014″ super elastic nickel titanium wire to a maximum of 590.7 g. for the 0.019″×0.025″ stainless steel wire when using CL. The amount of both static and kinetic friction in presence of misaligned canine bracket in the NCL group was less than the half of that shown by the CL group.

Clinic cases have demonstrated that the above-mentioned reduced friction combined with the pre-formed curves (65) of the ligature lead to a remarkable reduction of the orthodontic treatment time.

As shown in FIGS. 10-14, a ligature device according to the present invention is apt to be positioned on a conventional bracket by simply using a tool (P) of the type commonly used by orthodontists. The procedure shown in FIGS. 10-14 involves the following steps:

clamping the ligature, by means of a clamp type tool (P), in correspondence of a ring (6) thereof (FIG. 10);

engaging the opposed ring (6), that is the one not clamped by the tool (P), to the lower side (21) of the upper wings (2) of the bracket (FIGS. 11 and 12);

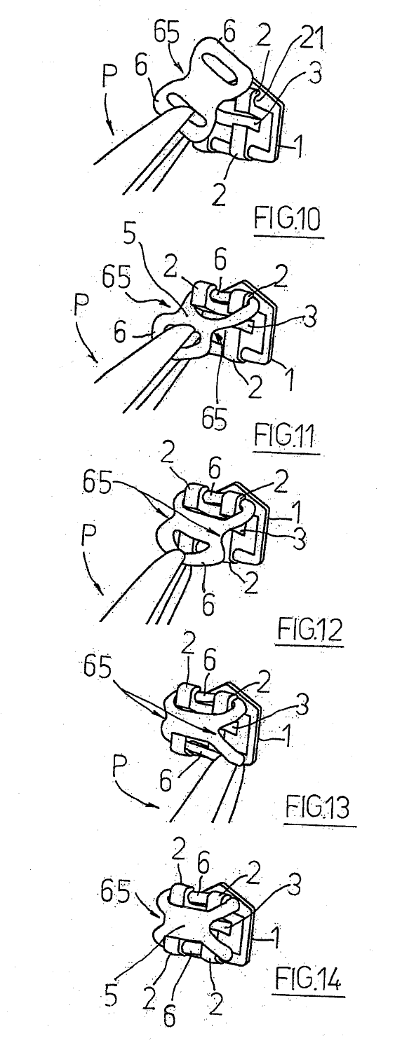

slightly stretching of the clamped ring and engaging the latter to the lower side (21) of the lower wings (2) of the bracket (FIGS. 13 and 14).

As shown in FIGS. 10-14 there is no need to stretch the ligature device to obtain the above-mentioned curves (65) and leave uncovered two opposed portions of the slot (3).

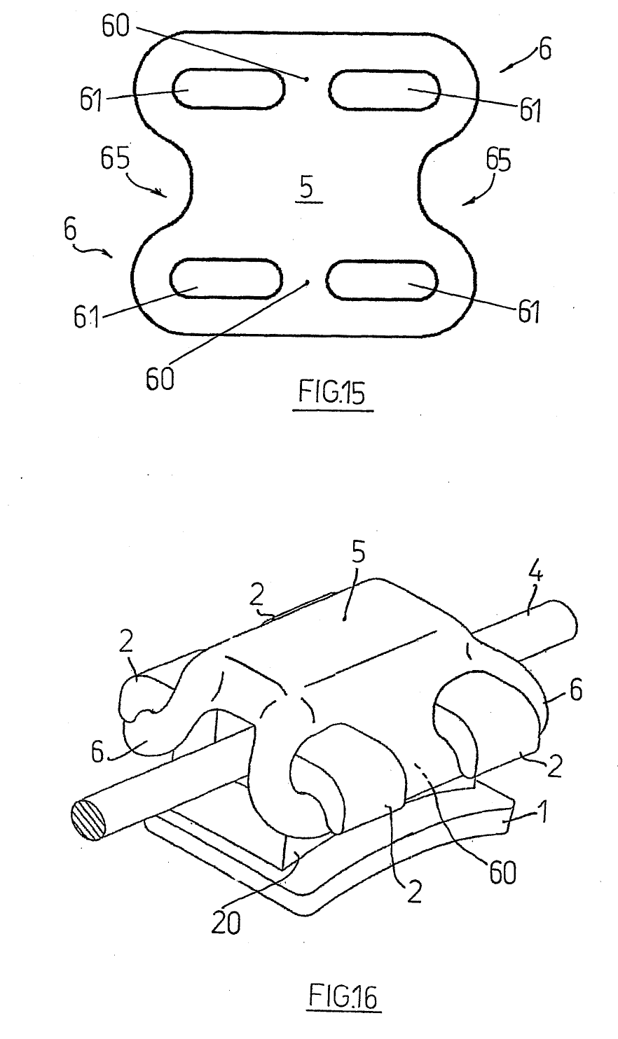

The embodiment shown in FIGS. 15 and 16 differs from the one previously described in that a central wall (60) is provided within each ring (6), thus subdividing each ring (6) into two smaller rings (61). Each of the smaller rings (61) is intended to be positioned astride of a corresponding wing (2) of the bracket. This feature of the ligature device allows an even more stable anchoring of the same to the orthodontic bracket. Practically, the construction details may vary in any equivalent way as far as the shape, dimensions, elements disposition, nature of the used materials are concerned, without nevertheless departing from the scope of the adopted solution idea and, thereby, remaining within the limits of the protection granted to the present patent.

While a specific embodiment of the invention has been shown and described in detail to illustrate the application of the principles of the invention, it will be understood that the invention may be embodied otherwise without departing from such principles.

TABLE 1
Descriptive statistics and statistical comparisons of static frictional forces (g)

| | Conventional ligatures (CL) | | | | | Ligatures of the present invention (NCL) | | | | | |
|---|---|---|---|---|---|---|---|---|---|---|---|
| | Mean | Median | SD | Min | Max | Mean | Median | SD | Min | Max | Sig. |
| 0.019″ × 0.025″ SS aligned br. | 590.7 | 587.3 | 38.1 | 529.1 | 656.2 | 8.3 | 3.0 | 10.5 | 1.3 | 31.7 | * |
| 0.014″ SE aligned br. | 156.4 | 155.0 | 10.8 | 133.6 | 173.6 | 0.7 | 0.5 | 0.5 | 0.2 | 1.6 | * |
| 0.014″ SE misaligned br. | 255.9 | 253.4 | 68.5 | 155.0 | 347.7 | 105.1 | 109.6 | 18.8 | 78.5 | 135.6 | * |

* p < 0.001

TABLE 2
Descriptive statistics and statistical comparisons of kinetic frictional forces (g)

| | Conventional ligatures (CL) | | | | | Ligatures of the present invention (NCL) | | | | | |
|---|---|---|---|---|---|---|---|---|---|---|---|
| | Mean | Median | SD | Min | Max | Mean | Median | SD | Min | Max | Sig. |
| 0.019″ × 0.025″ SS aligned br. | 541.6 | 538.6 | 41.7 | 491.4 | 631.6 | 0.9 | 1.0 | 0.4 | 0.4 | 1.6 | * |
| 0.014″ SE aligned br. | 95.6 | 92.3 | 20.6 | 66.3 | 137.7 | 0.1 | 0.1 | 0.1 | 0.0 | 0.4 | * |
| 0.014″ SE misaligned br. | 176.9 | 178.5 | 20.4 | 147.9 | 203.9 | 82.7 | 82.6 | 12.9 | 65.3 | 103.0 | * |

* p < 0.001

What is claimed is:

1. Ligature device for orthodontic brackets, the ligature device comprising:
an elastic body with a central portion and two lateral rings extending along a mesodistal direction of said central portion, said central portion having two mesial-distal sides and two gingival-occlusal sides, one lateral ring being positioned on one mesial-distal side and another lateral ring being positioned on another mesial-distal side such that said one lateral ring is opposite said another lateral ring with respect to said central portion, said lateral rings forming at least one curve corresponding to one of said gingival-occlusal sides in both a stretched position and in an un-stretched position, the vertex of said at least one curve being turned toward said central portion in said stretched position and said un-stretched position, the length (a) of each of said rings exceeding a length (c) of said central portion when said rings are in the stretched and in the un-stretched positions such that the ratio (c)/(a) is less than one in both said stretched and un-stretched positions.

2. A device according to claim 1, wherein said elastic body is a unitary structure.

3. A device according to claim 1, wherein said elastic body is composed of thermoplastic polyurethane.

4. A device according to claim 1, wherein said elastic body has a hardness range from Shore A80 to Shore A90.

5. A device according to claim 1, wherein said elastic body is symmetric.

6. A device according to claim 1, wherein said elastic body is asymmetric.

7. A device according to claim 1, wherein a central wall is provided within each ring to subdivide each ring into two smaller rings.

8. A ligature device for orthodontic brackets, the ligature device comprising:
an elastic body having a central portion and a first lateral ring and a second lateral ring, said first lateral ring and said second lateral ring extending along a mesodistal direction of said central portion, said central portion having a first mesial-distal side and a second mesial-distal side, said central portion having a first gingival-occlusal side and a second gingival-occlusal side, said first lateral ring being located on said first mesial-distal side and said second lateral ring being located on said second mesial-distal side, whereby said first lateral ring is opposite said second lateral ring, said first lateral ring and said second lateral ring having at least one pre-formed curve portion corresponding to said first gingival-occlusal side in both a relaxed position and a stretched position, said pre-formed curved portion having a vertex adjacent said central portion, the mesiodistal length of said first lateral ring and said second lateral ring exceeding the mesiodistal length of said central portion when said first lateral ring and said second lateral ring are in said stretched position and said relaxed position such that the ratio of the length of said central portion to the length of each said ring is less than one in both said stretched and said relaxed positions.

9. A device in accordance with claim 8, wherein said elastic body is one element.

10. A device in accordance with claim 8, wherein said elastic body is composed of thermoplastic polyutherane.

11. A device in accordance with claim 8, wherein said elastic body has a hardness range from Shore A80 to Shore A90.

12. A device in accordance with claim 8, wherein said elastic body is symmetric.

13. A device in accordance with claim 8, wherein said elastic body is asymmetric.

14. A device in accordance with claim 8, wherein a central wall is provided within each ring to subdivide each ring into two smaller rings.
